(19) United States
(12) Patent Application Publication
(10) Pub. No.: US 2003/0127024 A1
(43) Pub. Date: Jul. 10, 2003

(54) Silicatic coating mass with improved stability

(76) Inventors: Franz Heiberger, Augsburg (DE); Hermann Schlaffer, Neusass (DE)

Correspondence Address: Leopold Presser, Scully Scott Murphy & Presser, 400 Garden City Plaza, Garden City, NY, 11530, US

(21) Appl. No.: 10/181,281

(22) PCT Filed: Jan. 18, 2001
(86) PCT No.: PCT/EP01/00548

(30) Foreign Application Priority Data
Jan. 18, 2000 (DE) 10001831.9

(51) Int. Cl. C04B 12/04

(52) U.S. Cl. 106/634; 428/703

(57) ABSTRACT

The invention relates to a silicatic coating mass, a method for producing the same, the use thereof and a substrate that is coated with the silicatic coating mass. The silicatic coating mass comprises water glass or a mixture of water glass and silica sol. The molar ratio of SiO₂ and alkali oxide is 5 to 30 mol SiO₂ per mol alkali oxide. Said coating mass also comprises one or more organic ammonium compound/s, one or more filler/s and optionally other additives. The inventive silicatic coating mass is provided with increased shelf live when consisting of one component and the coated substrate is characterised by an increased stability against atmospheric influences.

The invention relates to a silicatic coating mass, a method for producing the same, the use thereof and a substrate coated with the silicatic coating mass.

Silicatic coating masses find use in a plurality of technical applications. These include the application of protective coatings on mineral substrates such as lime and lime cement plasters and concrete, on synthetic materials such as PVC and on metallic surfaces made of iron or non-ferric metals. The silicatic coating masses include, in particular, the purely inorganic silicate paints as well as dispersion silicate paints that may contain up to 5% by weight of inorganic moieties under DIN 18 363.

These silicatic coating masses are formulated in practice with pigments, fillers, water and water glass as the binding agent. Water glass is understood to be melts of alkali silicates, which are solidified in a glass-like fashion, and aqueous solutions thereof which are obtainable from alkali carbonates and SiO₂. The water glass binding agent causes the special properties of silicatic coating masses. The coating composition is silicified due to the evaporation of water and the reaction with carbon dioxide, i.e. the binding agent is converted into a water-insoluble silicatic network which may optionally include the components of the undercoat. Thereby, a very hard coating with high gas permeability is formed. The water glass used is generally produced by melting together quartz sand and alkali carbonate. As a rule, the molar ratios of SiO₂ to alkali oxide, the two main components of water glass, are set to not more than 4.

Coatings obtained from silicatic coating masses and which use a water glass binding agent have, however, the disadvantage that they tend to wash out alkali when acted upon by water, which may result in bright streaks, reduced bonding to the undercoat and thus chalking, i.e. an easy wiping off of particles. In particular in the case of chemical stress, such as acidic rain, or climatic stress, such as alternating frost and thaw, these coatings have proved to be of insufficient stability.

Increased stability with respect to such stress was found for silicatic coatings containing water glass with a higher molar ratio of SiO₂ to alkali oxide. However, it has not been possible to produce a coating mass for such coatings which is stable in storage since silicatic coating masses containing water glass at a molar ratio of SiO₂ to alkali oxide of >4 are not stable. The higher the SiO₂ content is, the more easily occurs gel formation, and thus solidification of the water glass. This problem was circumvented by providing two- or multi-component systems whose components could only be mixed directly prior to use. WO 95/29139 describes a silicate mass which comprises a water glass binding agent with a molar ratio of silica to alkali oxide of 4 to 25 and which further contains oxides from the group consisting of alumina, calcium oxide, titanium dioxide, magnesium oxide, zirconium oxide and/or boron oxide. However, such a silicate mass has a high reactivity and is therefore exclusively described as a multi-component system with a very short pot life in the mixed, one-component state. This is disadvantageous in particular for use in the field of paint coats since the components can only be mixed directly prior to use and must then be rapidly processed.

Consequently, the invention is based on the object of providing a silicatic coating mass with a high molar ratio of silica to alkali oxide, which is also stable in the one-component state and is suitable for the field of paint coats.

This object was surprisingly attained by a silicatic coating mass comprising water glass or a mixture of water glass and silica sol with a molar ratio of SiO₂ to alkali oxide of 5 to 30 mol SiO₂ per mol alkali oxide, one or more organic ammonium compound(s) and one or more filler(s).

A silicatic coating mass containing water glass or a mixture of water glass and silica sol with a molar ratio of SiO₂ to alkali oxide of 5 to 30 mol SiO₂ per mol of alkali oxide, and one or more organic ammonium compound(s), exhibits high storage stability in the ready-to-use, one-component state. As a rule, it has a storage stability of at least 6 months.

Preferably the molar ratio of SiO₂ to alkali oxide in the water glass, or in the mixture of water glass and silica sol, ranges from 10 to 25 mol SiO₂ per mol alkali oxide, more preferably from 15 to 26 mol SiO₂ per mol alkali oxide.

The alkali oxide of the water glass of the silicatic coating mass in accordance with the invention preferably is potassium oxide. Potassium oxide is preferred since, as compared to sodium oxide, it tends less to blooming and is less expensive than lithium oxide. The alkali oxide is preferably contained in an amount of from 0.5 to 3% by weight, more preferably of from 0.5 to 0.8% by weight, based on the total weight of the silicatic coating mass. Especially preferred is a content of alkali oxide of 0.5% by weight.

The reference to alkali oxides corresponds to the current practice in silicate analysis of indicating metal contents as oxides, even if these are actually present in the form of chemical compounds such as silicates or the like.

Silica sol is understood to be aqueous solutions of colloidal silicic acid. Preferably an alkaline silica sol is used. A solids content of 10 to 50% is also preferred.

Advantageously, the silica sol has moreover a mean particle size of <10 nm. The silica sols used according to the invention are, in addition, preferably characterized by a very uniform and fine distribution spectrum.

The silica gel may be present in a moiety of from 3 to 30% by weight, based on the total weight of the silicatic coating mass.

The water glass having a molar ratio of SiO₂ to alkali oxide of 5 to 30 mol SiO₂ per mol alkali oxide, or the mixture of water glass and silica sol, which is characterized by a molar ratio of SiO₂ to alkali oxide of 5 to 30 mol SiO₂ per mol alkali oxide, acts as a binding agent in the silicatic coating mass according to the invention.

The water glass, or the mixture of water glass and silica sol, having a molar ratio of SiO₂ to alkali oxide of 5 to 30 mol SiO₂ per mol alkali oxide is preferably contained in the silicatic coating mass according to the invention in an amount of from 3 to 40% by weight, more preferably of from 15 to 35% by weight, based on the total weight of the silicatic coating composition.

The organic ammonium compound(s) in the silicatic coating mass according to the invention preferably has (have) the following formula (I):

+NR¹R²R³R⁴ X⁻ (I)

with R¹, R² and R³ each being independently an alkyl group having 1 to 20 carbon atoms, which may optionally be substituted by a functional group, an aryl group having 6 to 20 carbon atoms, which may optionally be substituted by a functional group, or hydrogen, and with R⁴ being an alkyl group having 1 to 20 carbon atoms, which may optionally be substituted by a functional group, an aryl group having 6 to 20 carbon atoms, which may optionally be substituted by a functional group, hydrogen or —(CH₂)ₓ—N⁺R⁵R⁶R⁷Y⁻, with R⁵, R⁶ and R⁷ each being independently an alkyl group having 1 to 20 carbon atoms, which may optionally be substituted by a functional group, an aryl group having 6 to 20 carbon atoms, which may optionally be substituted by a functional group, or hydrogen, wherein at least one of R¹, R², R³ and R⁴ is not hydrogen, x is an integer between 1 and 10, and X⁻ and Y⁻ each may be the same or different and are anions. The functional group can be e.g. a hydroxy group, an amino group, an amino alkyl group having 1 to 6 carbon atoms, a thiol group or an alkoxy group having 1 to 6 carbon atoms, preferably a hydroxy group. The anion can be freely selected in as far as it does not reduce the effect of the organic ammonium compound; thus, the anion may be F⁻, Cl⁻, Br⁻, I⁻ or OH⁻, for example.

Especially preferred is an organic ammonium compound of the formula (II):

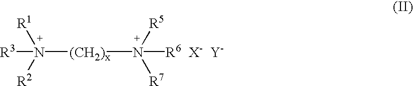

with R¹, R², R⁵ and R⁷ each being independently an alkyl group having 1 to 20 carbon atoms, an aryl group having 6 to 20 carbon atoms, or hydrogen. R³ and R⁶ each are independently a hydroxy-substituted alkyl group having 1 to 6 carbon atoms, x is an integer between 1 and 6, and X⁻ and Y⁻ may be the same or different and are in each case an anion, e.g. F⁻, Cl⁻, Br⁻, I⁻ or OH⁻.

Preferably the alkyl groups of the formulae (I) or (II) contain 1 to 6 carbon atoms, and selected examples are methyl, ethyl, propyl, isopropyl, n-butyl, tert-butyl, pentyl, hexyl and cyclohexyl. Selected examples of a hydroxy-substituted alkyl group having 1 to 6 carbon atoms are hydroxymethyl, hydroxyethyl, 1-hydroxypropyl and 2-hydroxypropyl.

Especially preferred is an organic ammonium compound, in which R¹, R², R⁵ and R⁷ each are a methyl group, R³ and R⁶ each are a 2-hydroxypropyl group, x=6 and X⁻ and Y⁻ each are OH⁻.

The content of the organic ammonium compound(s) in the silicatic coating mass ranges preferably from 0.1 to 3% by weight, likewise preferably from 1 to 3% by weight and more preferably from 1.5 to 3% by weight, based on the total weight of the coating composition.

The silicatic coating mass according to the invention comprises one or more fillers, their content ranging preferably from 10 to 45% by weight, based on the total weight of the silicatic coating mass. Quartziferous fillers, calcitic fillets, layer silicates and/or feldspar can e.g. be used as fillers.

The silicatic coating mass according to the invention may further contain a polymer. Polymer-containing silicatic coating masses are, in particular, used as dispersion silicate paints. The addition of a polymer results in higher flexibility of the coating obtained after silicification, which is advantageous, in particular, on natural substrates and polymer substrates. In accordance with DIN regulation 18 363, paragraph 2.4.1, dispersion silicate paints may contain at the most 5% organic moieties. Irrespective of this DIN regulation, however, a polymer content of up to 15% by weight, based on the total weight of the silicatic coating mass, in particular of from 1 to 15% by weight, is advantageous. Especially preferred is a polymer content of from 3 to 10% by weight. As a rule, the polymer is incorporated into the silicatic coating mass in the form of a dispersion. The solids content of the polymer dispersion is preferably from 20 to 60% by weight. Preferably the polymer is a (meth)acrylate homopolymer or a (meth)acrylate copolymer. A butyacrylate-methylmethacrylate copolymer or a styrene-acrylate copolymer is especially preferred.

Furthermore, the silicatic coating mass may comprise oxides from the group consisting of alumina, calcium oxide, titanium dioxide, magnesium oxide, zirconium oxide and/or boron oxide.

Moreover, for adaptation to a desired color, pigments may be contained in the silicatic coating mass. Mineral oxides, in particular oxides having a rutile or spinel structure, such as e.g. iron oxides, are used to advantage. The pigments are preferably contained in the silicatic coating mass in an amount of from 5 to 50% by weight.

Moreover, the silicatic coating mass may contain e.g. thickeners, hydrophobing agents, dispersing agents and/or defoaming agents as additives.

Examples of thickening agents are polysaccharides, cellulose ether and bentonite. Their content may amount to 0.1 to 5% by weight, based on the total weight of the silicatic coating mass.

The hydrophobing agent may comprise, for example, polysiloxanes and, in particular, amino-functional polysiloxanes. The hydrophobing agent may be present in an amount of from 0.1 to 5% by weight, based on the total weight of the silicatic coating mass.

The dispersing agents used may be, for instance, sodium and potassium polyacrylates. The dispersing agent is preferably present in an amount of from 0.1 to 0.5% by weight, based on the total weight of the silicatic coating mass.

Mineral and/or silicone oils may be present in the silicatic coating mass as defoaming agents. Preferably the amount of the defoaming agent present ranges from 0.1 to 1% by weight, based on the total weight of the silicatic coating mass.

Moreover, the silicatic coating mass may contain water, preferably in an amount of from 15 to 50% by weight, based on the total weight of the silicatic coating composition.

Although the advantages of the invention are especially evident in a one-component silicatic coating mass, the splitting-up of the silicatic coating mass into two components is also possible. In this case, one component preferably contains the filler and optionally further additives, such as pigments, and the second component contains the water glass or the mixture of water glass and silica sol having a molar ratio of SiO₂ to alkali oxide of 5 to 30 mol SiO₂ per mol alkali oxide, and the organic ammonium compound.

The silicatic coating mass according to the invention can be produced by mixing the water glass, or the mixture of water glass and silica sol, having a ratio of SiO₂ to alkali oxide of 5 to 30 mol SiO₂ per mol alkali oxide, with one or several organic ammonium compound(s), wherein the filler(s) and optionally further additives, such as pigments, are added prior to, or after, the mixing of the water glass, or the mixture of water glass and silica sol, with the organic ammonium compound. If a polymer is added to the silicatic coating mass, it is preferably added in-the form of a polymer dispersion prior to the mixing of the water glass, or the mixture of water glass and silica sol, with the organic ammonium compound.

Further variants for the production of the silicatic coating mass will now be presented.

The silicatic coating mass according to the invention can be produced by initially dispersing the filler(s) and optionally the pigments in water, and then adding the organic ammonium compound(s) and thereafter optionally the polymer in the form of a dispersion. After thorough dispersing, the water glass, or the mixture of water glass and silica sol, and then optionally further additives, e.g. thickeners and/or hydrophobing agents, are added. A dispersion that is as homogeneous as possible is obtained by further stirring.

Alternatively, the silicatic coating mass according to the invention can be produced as follows:

At first, the water glass, or the mixture of water glass and silica sol, is mixed with the organic ammonium compound(s). Pigments may optionally be added thereto. Subsequently, the filler(s) and optionally a polymer dispersion are stirred into the mixture. Finally, further additives, such as a thickener and/or a hydrophobing agent, may optionally be added.

The silicatic coating mass according to the invention can be used for coating. substrates.

Advantageously, the silicatic coating mass in accordance with the invention can be used for protecting substrates against atmospheric influences.

The silicatic coating mass is suitable for all applications for which silicate paints and/or dispersion silicate paints have hitherto been used. These also include, in addition to protective coatings against atmospheric influences, coatings for decorative purposes or ornaments.

The invention also includes substrates which are coated with the silicatic coating mass according to the invention. Coated substrates can be obtained by applying the silicatic coating mass according to the invention onto a substrate, e.g. by means of dipping, spreading, rolling, pouring or spraying, with subsequent silicification taking place.

The substrates onto which the silicatic coating mass according to the invention can be applied are preferably mineral substrates, metallic substrates, natural substrates or plastic substrates.

Special examples of mineral substrates include mortar (cf. e.g. DIN 18555), plasters, e.g. lime and cement plasters, concrete, natural stone, e.g. lime sandstone, and brickwork.

Metallic substrates are e.g. zinc-plated surfaces or aluminum substrates.

For instance, cellulose-containing materials (e.g. paper, cardboard, wood, wood-containing materials such as chipboards), biologically degradable polymers (e.g. protein- or starch-containing materials) and textile materials (e.g. cotton, linen) are understood by natural substrates.

Wood and wood-containing materials are especially preferred cellulose-containing materials.

Plastic substrates can be, for example, poly(meth)acrylates, polycarbonates, polystyrenes, polyethylene glycols and/or PVC.

Substrates also include substrates provided with a priming. A priming may serve e.g. to improve adhesion between the non-primed substrate and the silicatic coating mass and/or the coating obtained by means of application and silicification. Examples of primings, onto which the silicatic coating mass can be applied for. producing a coated substrate, include e.g. primings on the basis of polyorganosiloxanes which may optionally be modified.

Coated substrates according to the invention excel by the advantages offered by high water resistance, adhesion and abrasion resistance. These advantages result from the reduction and/or absence of washing-out of alkali so that the coating remains in its original state, i.e. the state at the time when silicification is concluded. The formation of bright streaks (chalking), an increase in porosity and an associated reduced bonding of the coating to the substrate (erosion of the coating) is considerably delayed or prevented.

The advantageous properties of the coating mass according to the invention, or of the coated substrates according to the invention, can be proved by means of the following test procedures.

1. Method for Testing Water Resistance (Early Water Resistance):

Two coatings of the silicatic coating mass to be tested are successively knife-coated onto fiber-reinforced cement plates (e.g. Eterplan). The first coating is applied with a width of 80 mm and a length of 430 mm, and the second coating is applied with a width of 60 mm and a length of also 430 mm. The time interval between the coatings is at least 12 hours, the radial screw clearance of the doctor blade is 225 μm. The fiber-reinforced cement plates, the coating composition and the coated plates are stored under standard atmospheric conditions (23° C., 50% relative humidity). Four hours after applying the second coating, 50 ml of completely demineralized water are dripped onto the surface of the coating by means of a burette. The burette is adjusted in such a manner that the 50 ml water are dripped onto the surface within 10 minutes. The sample surface is disposed at an angle of 135° to the burette. After completely drying the surface, i.e. as a rule after 24 hours, the samples are examined. The following distinction is made depending on the intensity of the curtaining marks:

| | |
|---|---|
| Class 0: | no curtaining visible |
| Class 1: | visible curtaining |
| Class 2: | extremely visible curtaining |
| Class 3: | the paint coat is washed out. |

2. Method for Testing Adhesion (Adhesive Tensile Strength) (According to DIN 18 555 Part 6):

The silicatic coating mass is applied onto concrete plates of the strength class B 55 according to DIN 1045, which have a tear-off strength of at least 3 N/mm². The finished samples are stored for at least 14 days under standard atmospheric conditions (23° C., 50% relative humidity). The measurement of the adhesive tensile strength is carried out in accordance with DIN 18 555, Part 6, item 5 at a rate of loading of 100 N/s.

3. Method for Testing Abrasion Resistance (Washing and Scrub Resistance) (According to DIN 53 778, Part 2);

Deviating from the DIN standard, the following substrates are used and the coating is produced as described below. Two coatings of the coating composition are successively knife-coated onto fiber-reinforced cement plates (e.g. Eterplan).

The first coating is applied with a width of 80 mm and a length of 430 mm, and the second coating is applied with a width of 60 mm and a length of also 430 mm. The time interval between the coatings should be at least 12 hours, the radial screw clearance of the doctor blade is 225 μm. The fiber-reinforced cement plates, the coating composition and the coated substrates are stored under standard atmospheric conditions (23° C., 50% relative humidity). Further testing occurs in accordance with DIN 53 778, Part 2.

As regards spreadability and sprayability, the silicate coating masses according to the invention did not show any recognizable difference during a 6-month storage period to the dispersion silicate paints known up until now.

The coated substrates obtained by means of the application and silicification of the coating masses according to the invention are characterized by high stability against chemical influences, such as acidic rain, and atmospheric influences, such as alternating frost and thaw.

The invention will now be explained in more detail in the following by means of the examples.

### EXAMPLE 1

A mixture of 3.8% by weight of a 30% potash water glass solution and 17% by weight of a silica sol having a particle size of 9 nm and a solids content of 20%, which mixture has a molar ratio of SiO₂ to potassium oxide of 10 mol SiO₂ per mol potassium oxide, is mixed with 1.5% by weight of (CH₃)₃ [CH₃CH (OH) CH₂]N⁺—(CH₂) ₆—⁺N(CH₃)₂ [CH₂CH(OH) CH₃]OH⁻OH⁻ (N,N′-di(2-hydroxypropyl)—N,N′-tetramethyl hexylene diamine, 20% aqueous solution). After the addition of 10.5% by weight of iron oxide, stirring is carried out for 5 minutes. Subsequently, 29.3% by weight of layer silicate mixture (kaolinite, chlorite, muscovite) and 6.0% by weight of butyl methacrylate/methyl methacrylate copolymer (as a 50% dispersion) are added by means of stirring so that a homogenous dispersion is formed. After the addition of 0.2% by weight of bentonite, 0.1% by weight of xanthane and 1.5% by weight of an aqueous amino-functional polydimethyl siloxane emulsion (solids content 50%) (Wacker BS 1306), the mass is rendered ready for use by adding 30.1% by weight of water. The silicatic coating mass obtained is used for coating a concrete substrate.

The coated substrate is characterized by an early water resistance of Class 0, an adhesive tensile strength of 3 to 4 N/mm² and a washing and scrub resistance of >10,000 cycles.

### EXAMPLE 2

35% by weight of an 18% potash water glass solution with a molar ratio of SiO₂ to potassium oxide of 6 are mixed with 0.5% by weight of N,N′-di(2-hydroxypropyl)-N,N′-tetramethyl hexylene diamine (20% aqueous solution). 13.95% by weight of potassium aluminum silicate, 9% by weight of calcium carbonate, 8% by weight of dehydrated aluminum silicate hydrate, 4% by weight of calcium fluoride and 0.4% by weight of silica as fillers, and 7.5% by weight of an aqueous dispersion of a methyl methacrylate butyl acrylate copolymer (solids content 50%) are added by stirring so that a homogeneous dispersion is formed. After the addition of 1% by weight of an aqueous aminoalkyl polydimethyl siloxane emulsion (solids content 50%) (Wacker BS 1306), 0.25% by weight of tetrasodium-N-(1,2-dicarboxyethyl)-N-alkyl sulfosuccinamide, 0.2% by weight of a mixture of hydrophobic silicic acid, liquid hydrocarbons, non-ionogenic emulsifiers and synthetic copolymers (Agitan 281), 0.125% by weight of xanthane and 0.1% by weight of sodium carboxymethyl cellulose, the mass is rendered ready for use by adding 19.975% by weight of water. The silicatic coating mass obtained is used for coating a mineral substrate (lime cement plaster).

### EXAMPLE 3

22% by weight of a filler (intergrowth of chloride, quartz and mica) are dispersed in 28.6% by weight of water. 2% by weight of (N,N′-di(2-hydroxypropyl)-N,N′-tetramethyl hexylene diamine (20% aqueous solution) are added. Subsequently, 9% by weight of an aqueous dispersion of a butyl acrylate/methyl methacrylate copolymer (solids content 50%) are added. A mixture of 20% by weight of silica sol (particle size 7 to 8 nm, solids content 30%) and 6% by weight of a 21% potash water glass solution (molar ratio of SiO₂ to potassium oxide=10) are added by stirring. After dispersing said components, 10% by weight of a polysaccharide solution (solids content 5%) are added 0.2% by weight of an aqueous emulsion of an aminoalkyl-substituted polydimethyl siloxane (Wacker BS 1306) (solids content 50%), 0.2% by weight of tetrasodium-N-(1,2-dicarboxyethyl)-N-alkyl sulfosuccinamide and 0.2% by weight of a mixture of hydrophobic silicic acid, liquid hydrocarbons, non-ionogenic emulsifiers and synthetic copolymers (Agitan 281) are added as further additives and stirred until a dispersion, which is as homogeneous as possible, is obtained. The prepared silicatic coating mass is used for coating a natural stone substrate (sandstone).

### EXAMPLE 4

Initially, 19% by weight of an aqueous dispersion of a (meth)acrylic acid copolymer (solids content 50%) are prepared. A mixture of 6% by weight of a 21% potash water glass solution and 10% by weight of silica sol (solids content 30%, average particle size 7 to 8 nm) (molar ratio of SiO₂ to potassium oxide=10) are mixed with 1% by weight of N′,N-di(2-hydroxypropyl)-N,N′-tetramethyl hexylene diamine and added to the copolymer dispersion. Subsequently, 22% by weight of a filler (intergrowth of chloride, quartz and mica), 10% by weight of a 5% polysaccharide solution, 2% by weight of an aqueous emulsion of an amino-alkyl-group-containing polydimethyl siloxane (Wacker BS 1306) (solids content 50%), 0.2% by weight of tetrasodium-N-(1,2-dicarboxyethyl)-N-alkyl sulfosuccinamide and 0.2% by weight of a mixture of hydrophobic silicic acid, liquid hydrocarbons, non-ionogenic emulsifiers and synthetic copolymers (Agitan 281) are added and filled with 29.6% by weight of water. The obtained silicatic coating mass is used for coating a mixed undercoat containing organic fibers (wood-fiber-reinforced cement substrate).

1. A silicatic coating mass comprising
water glass or a mixture of water glass and silica sol having a molar ratio of SiO₂ to alkali oxide of 5 to 30 mol SiO₂ per mol alkali oxide,
one or more organic ammonium compound(s), and
one or more filler(s).

2. A silicatic coating mass according to claim 1, characterized in that the molar ratio of SiO₂ to alkali oxide is 10 to 25 mol SiO₂ per mol alkali oxide.

3. A silicatic coating mass according to claim 2, characterized in that the molar ratio of SiO₂ to alkali oxide is 15 to 25 mol SiO₂ per mol alkali oxide.

4. A silicatic coating mass according to one or more of the preceding claims, characterized in that the alkali oxide is potassium oxide.

5. A silicatic coating mass according to one or more of the preceding claims, characterized in that the silica sol has an average particle size of <10 nm.

6. A silicatic coating mass according to one or more of the preceding claims, characterized in that the organic ammonium compound(s) has (have) the following formula (I):
+NR¹R²R³R⁴ X⁻ (I)
with R¹, R² and R³ each being independently an alkyl group having 1 to 20 carbon atoms, which may optionally be substituted by a functional group, an aryl group having 6 to 20 carbon atoms, which may optionally be substituted by a functional group, or hydrogen, and with R⁴ being an alkyl having 1 to 20 carbon atoms, which may otionally be substituted by a functional group, an aryl group having 6 to 20 carbon atoms, which may optionally be substituted by a functional group, hydrogen or —(CH₂)x—N⁺R⁵R⁶R⁷Y⁻, with R⁵, R⁶ and R⁷ each being independently an alkyl group having 1 to 20 carbon atoms, which may optionally be substituted by a functional group, an aryl group having 6 to 20 carbon atoms, which may optionally be substituted by a functional group, or hydrogen, and wherein at least one of R₁,R², R³ and R⁴ is not hydrogen, x is an integer between 1 and 10, and X⁻ and Y⁻ each may be the same or different and are anions.

7. A silicatic coating mass according to claim 6, characterized in that the organic ammonium compound is a compound of the following formula (II): 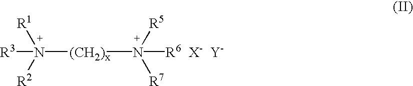
with R¹, R², R⁵ and R⁷ each being independently an alkyl group having 1 to 20 carbon atoms, an aryl group having 6 to 20 carbon atoms, or hydrogen. R³ and R⁶ each are independently a hydroxy-substituted alkyl group having 1 to 6 carbon atoms, x is an integer between 1 and 6, and X⁻ and Y⁻ may be the same or different and are in each case an anion.

8. A silicatic coating mass according to claim 7, characterized in that R¹, R², R⁵ and R⁷ each are a methyl group, R³ and R⁶ each are a 2-hydroxypropyl group, x=6 and X⁻ and Y⁻ each are OH⁻.

9. A silicatic coating mass according to one or more of the preceding claims, characterized in that it further comprises a polymer.

10. A silicatic coating mass according to claim 9, characterized in that the polymer is a (meth)acrylate homopolymer or a (meth)acrylate copolymer.

11. A method for producing a silicatic coating mass according to one or more of claims 1 to 10, characterized in that the water glass, or the mixture of water glass and silica sol having a ratio of 5 to 30 mol SiO₂ per mol alkali oxide, and the organic ammonium compound(s) are mixed, the filler(s) and optionally further additives are added prior to, or after, the mixing of the water glass, or the mixture of water glass and silica sol, with the organic ammonium compound(s), and water may optionally be added to render the mass ready-for-use.

12. A use of a silicatic coating mass according to one or more of claims 1 to 10 for coating substrates.

13. A coated substrate obtainable by the application of the silicatic coating mass according to one or more of claims 1 to 10 on a substrate and subsequent silicification.
